(19) United States
(12) Patent Application Publication
(10) Pub. No.: US 2014/0136246 A1
(43) Pub. Date: May 15, 2014

(54) Method of Stimulating Digital Sales

(71) Applicant: Joshua Newby-Ray, Macon, GA (US)

(72) Inventor: Joshua Newby-Ray, Macon, GA (US)

(73) Assignee: DIGIDOT LLC, Macon, GA (US)

(21) Appl. No.: 13/674,938

(22) Filed: Nov. 12, 2012

(51) Int. Cl. G06Q 30/02

(52) U.S. Cl. CPC G06Q 30/0252
USPC 705/5

(57) ABSTRACT

A method of stimulating digital media sales is disclosed. In one embodiment, a method of stimulating digital sales is provided, comprising selling a ticket to a mass entertainment event to a customer; generating a unique voucher code; coupling the voucher code to the ticket; coupling goods or services to the unique voucher code; and making the goods or services available for redemption via an electronic application. In another embodiment method of stimulating digital sales is provided, comprising selling a ticket to a mass entertainment event to a customer; generating a unique voucher code; coupling the voucher code to the ticket; coupling goods or services to the unique voucher code; making the goods or services available for redemption via an electronic application; and directing the customer to a vendor where the goods or services can be redeemed.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### ATTORNEY DOCKET NUMBER

DiGi-0001

### FIELD OF THE INVENTION

This invention relates to a method of increasing digital sales. More particularly, the present invention relates to a business method of coupling the sale of digital licensing rights with the sale of tickets to live or mass entertainment events.

### BACKGROUND OF THE INVENTION

The internet shrunk the world. News, data, and other information can move freely from one user to another faster than the blink of an eye. The advantages associated with the invention of the internet are infinite. Communication has never been easier and the way people think and work together has been forever changed. However, these changes have had a negative effect on the music industry. Prior to the internet, the music industry based its business model on selling complete albums. When a consumer wanted to hear one or several hits from an artist at home, he or she would go to a local store and purchase an album. Typically, a user would pay between $15 and $18 for a complete album just to hear a few songs.

In 1999, Napster, a peer-to-peer (P2P) software, was unleashed on the world. Napster allowed users to transfer digital files to each other via the internet. While this promoted the free flow of knowledge and information, it enabled large-scale copyright infringement of media files, particularly songs. Rather than going to the store to purchase a complete album to hear just one song, a user could download a desired song from another user for free. The music industry was not amused, and supported litigation against software developers and end users. The use was so rampant that not only were deeper pocket file sharing hosts like Limewire being prosecuted, individual users themselves were being prosecuted, exposing them to high judgments that they could not afford to pay.

The wide use of P2P file sharing has subsided in the United States for several reasons. First, the litigation against software developers and users has been effective. More importantly, the industry changed its business model to adapt to the new marketplace. Consumers became accustomed to having access to the one or two songs they wanted to hear rather than being forced to buy an entire album. Now, a consumer can purchase a single song via a vendor such as iTunes or Amazon for roughly $1. Full albums usually cost $9.99. While this has allowed the industry to fight back against illegal downloads, the industry has not fully recovered. According to the RIAA, the music industry went from $14.6 billion prior to the launch of Napster to just $7 billion in 2011.

Although the way music is sold has shifted from whole albums to a system where consumers can buy just a few songs, very little has changed with the way the industry is structured. Artists continue to make full albums rather than singles. Some tracks may have a featured artist or producer. Engineers, technicians, etc. may have involvement with only part of an album. In the past, if one successful track carried an album, the costs and fees associated with the entire album would be recovered and everyone involved shared in the revenues. Now, if a full album is sold, all of the parties involved share their pieces of $9.99. But if just one track is sold, only the parties involved in making that track share in the sale price. The rest of the team involved in making the other tracks on the album is left uncompensated. One study by the Institute for Policy Innovation pegs the annual harm at $12.5 billion dollars in losses to the U.S. economy as well as more than 70,000 lost jobs and $2 billion in lost wages to American workers.

Unlike record sales, concert sales have not suffered since the launch of Napster. They have actually increased. Artists point to the increased availability of the songs and the exposure of their music to a larger audience to account for the increase in concert attendance. In fact, most recording artists would be willing to give their music away for free to stimulate concert attendance. Revenues from live events tend to favor the artist rather than the record company. The record companies make the majority of their revenues from album sales. Thus, record companies aggressively support promotional tours to stimulate album sales. However, sold out venues often do not lead to increased album sales. Accordingly, what is needed is a method of capitalizing on increased concert attendance to stimulate slumping album sales.

### SUMMARY OF INVENTION

The method of the present invention solves the problems confronted in the art in a simple and straightforward manner. What is provided is a method of stimulating digital sales, comprising selling a ticket to a mass entertainment event to a customer; generating a unique voucher code; coupling the voucher code to the ticket; coupling goods or services to the unique voucher code; and making the goods or services available for redemption via an electronic application. What is further provided is a method of stimulating digital sales, comprising selling a ticket to a mass entertainment event to a customer; generating a unique voucher code; coupling the voucher code to the ticket; coupling goods or services to the unique voucher code; making the goods or services available for redemption via an electronic application; and directing the customer to a vendor where the goods or services can be redeemed.

### DETAILED DESCRIPTION OF THE INVENTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

In the preferred embodiment, a method 100 may comprise a series of steps 101 to 107 to stimulate digital sales. Step 101 is selling a ticket 101a to a mass entertainment event 101b to a customer 101c. The mass entertainment event 101b may be a concert, a movie, a sporting event, or a festival, for example. In the preferred embodiment, the mass entertainment event 101b would be specifically promoted to stimulate a good or service 104a, such as a music album, for example. Step 102 is generating a unique voucher code 102a. The unique voucher code 102a may be a QR code, a bar code, or an alphanumeric sequence, for example. Step 103 is coupling the unique voucher code 102a to the ticket 101a. The unique voucher code 102a may be specifically generated for each individual ticket 101a so that one customer 101c is only able to redeem one good or service 104a, for example.

Step 104 is coupling goods or services 104a to the unique voucher code 102a. In the preferred embodiment, the unique voucher code 102a may identify a single good or service that may be sold with the ticket. For example, when the mass entertainment event 101a is a concert by a single recording artist, the goods or services 104a will be that recording artist's music album. Thus, in this example, the ticket 101a to the mass entertainment event 101b sold to customer 101c also includes the recording artist's album in the ticket price. This method of coupling goods or services 104a to a ticket 101a capitalizes on the recording industry's current market climate. As explained above, concert attendance has increased while album sales have decreased. By including the rights to an album in a ticket sale, the number of albums sold as the result of a concert should equal the number of concertgoers.

Step 105 is making the goods or services 104a available for redemption 105a by the customer 101c at a predetermined date 105b. For example, if the mass entertainment event 101b is a concert by an artist to promote the artist's album that will be released at a later date, the predetermined date 105b may be set as the album release date. If the goods or services 104a are the artist's album, customers 101c that purchased a ticket 101b to the concert may not be able to redeem the album until the predetermined date 105b. In this situation, the goods or services 104a would be considered deferred.

In certain embodiments, the method 100 may include steps 106 and 107. Step 106 is entering the unique voucher code 102a into an electronic application 106a. The unique voucher code 102a may be a QR code, a bar code, or an alphanumeric sequence. The electronic application 106a may be a website, a computer program, or a mobile application for a handheld device, such as a cellular phone or a tablet computer. For example, if the unique voucher code 102a is a QR code or some other type of graphic code, the unique voucher code 102a may be placed directly on the ticket 101a. If the code 102a is a graphic code and placed directly on the ticket 101a, then the electronic application 106a may be configured to scan the code 102a. If the unique voucher code 102a is some alphanumeric string, for example, the electronic application 106a may be configured for a customer 101c to enter the code 102a in manually.

Once the customer 101a has entered or scanned the code 102a into the electronic application 106a, step 107 directs the customer 101c via the electronic application 106a to a vendor 107a to where the goods or services 104a can be redeemed. For example, if the goods or services 104a are a music album, the electronic application 106a will direct the customer 101a to vendor such as iTunes or Amazon where the customer 101a may download or order the album. Alternatively, the electronic application 106a may directly deliver the goods or services 104a to the customer 101a without the use of a vendor. The electronic application 106a may also have a reminder mechanism 106b where it may be programmed to remind the customer 101c to download or purchase the goods or services 104a if the customer 101c has not yet done so.

The following is a list of reference numerals:

LIST OF REFERENCE NUMERALS

| (No.) | (Description) |
|---|---|
| 100 | Method of stimulating digital sales |
| 101 | Step |
| 101a | Ticket |
| 101b | Mass entertainment event |
| 101c | Customer |
| 102 | Step |
| 102a | Unique voucher code |
| 103 | Step |
| 104 | Step |
| 104a | Goods or services |
| 105 | Step |
| 105a | Redemption |
| 105b | Predetermined date |
| 106 | Step |
| 106a | Electronic application |
| 107 | Step |
| 107a | Vendor |

All measurements disclosed herein are at standard temperature and pressure, at sea level on Earth, unless indicated otherwise. All materials used or intended to be used in a human being are biocompatible, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

What is claimed is:

1. A method of stimulating digital sales, comprising:
selling a ticket to a mass entertainment event to a customer;
generating a unique voucher code;
coupling the voucher code to the ticket;
coupling goods or services to the unique voucher code; and
making the goods or services available for redemption via an electronic application.

2. The method of claim 1, wherein the mass entertainment event is a concert.

3. The method of claim 1, wherein the mass entertainment event is a movie.

4. The method of claim 1, wherein the mass entertainment event is a sporting event.

5. The method of claim 1, wherein the mass entertainment event is a festival.

6. The method of claim 1, wherein the goods or services are digital media download rights.

7. The method of claim 1, wherein the goods or services are deferred.

8. The method of claim 1, wherein the unique code is a QR code.

9. The method of claim 1, wherein the goods or services are available at a predetermined date.

10. The method of claim 9, wherein the predetermined date is an album release date.

11. The method of claim 1, further comprising including the cost of the goods or services in the ticket price.

12. The method of claim 1, wherein the goods or services are available for redemption via an internet download.

13. The method of claim 1, wherein the electronic application is a mobile application.

14. The method of claim 13, wherein the electronic application scans the unique voucher code.

15. The method of claim 1, further comprising directing the customer to a vendor where the goods or services can be redeemed.

16. The method of claim 1, further comprising reminding a purchaser of the ticket that the goods or services are available for redemption.

17. A method of stimulating digital sales, comprising:
selling a ticket to a mass entertainment event to a customer;
generating a unique voucher code;
coupling the voucher code to the ticket;
coupling goods or services to the unique voucher code;
making the goods or services available for redemption via an electronic application; and
directing the customer to a vendor where the goods or services can be redeemed.

18. The method of claim 17, wherein the electronic application is a mobile application.

19. The method of claim 18, wherein the electronic application scans the unique voucher code.

20. The method of claim 17, further comprising reminding a purchaser of the ticket that the goods or services are available for redemption.
